(19) United States
(12) Patent Application Publication
(10) Pub. No.: US 2015/0047776 A1
(43) Pub. Date: Feb. 19, 2015

(54) METHOD OF ELEVATING QUALITY OF PRINTED MATTER BY POST-TREATMENT INCLUDING GLOSS AND NON-GLOSS TREATMENT ON DIGITAL PRINTED MATTER

(71) Applicant: GMP Co., Ltd., Gyeonggi-do (KR)

(72) Inventor: Yang-Pioung KIM, Gyeonggi-do (KR)

(73) Assignee: GMP Co., Ltd., Gyeonggi-do (KR)

(21) Appl. No.: 13/970,079

(22) Filed: Aug. 19, 2013

(51) Int. Cl. B41M 7/00; G03G 15/00; B41J 11/00

(52) U.S. Cl. CPC B41M 7/009; B41J 11/002; G03G 15/6585
USPC 156/247

(57) ABSTRACT

Provided is a method of elevating a quality of a printed matter by performing a post-treatment including a gloss and non-gloss treatment on a digital printed matter and to a method which performs a post-treatment including a gloss or a non-gloss, and a gloss and non-gloss treatment on an entire printed surface of the digital printed matter or on a partial specific printed surface to elevate a quality of a printed matter.

### BACKGROUND OF THE INVENTION

The present invention relates to a method of elevating a quality of a printed matter by performing post-treatments including gloss and non-gloss treatments on digital printed matter, and more particularly, to a method which performs post-treatments including a gloss treatment or a non-gloss treatment, and a gloss and non-gloss treatment on an entire surface to be printed of a digital printed matter or on a partial specific surface to he printed to elevate a quality of a printed matter

All printed matters may he first obtained from a simple paper and the simple paper is printed to be a book or a photograph, which may elevates a value of the printed matter. In other words, various post-treatments are performed on the most printed matter to add a value by a separate post-treatment after forming the printed matter in accordance with the application so as to improve a quality of the printed matter to elevate the quality of the printed matter.

Currently, most of machines and consumables for a printing post-treatment have been developed so as to be suitable for an offset printed matter which has been used for a long time.

Further, in the case of the offset printing, it is understood that a paper having a size of 1020×720 is used as a basic size so that sizes of consumables required for all post-treatments have been already determined to be the same as the basic size.

However, a digital printer generally uses a paper having a size of 450×320 as a basic size so that it is difficult or very inconvenient to use post-treatment equipment for offset printing or a cost for the post-treatment is significantly increased.

An object of the present invention is to develop a post-treatment method which is suitable for a small quantity and multi item digital printed matter whose market is expanding in recent year and to try to improve a quality of a digital printed matter to elevate the quality of the printed matter.

The post-treatment method for the digital printed matter is a method of elevating a quality of a digital printed matter by a post-treatment including a processing which may take advantage of a characteristic of a digital printed matter, specifically, a characteristic of a thermoplastic resin based toner or ink to pressurize a matt-treated film or a film having a highly smoothened surface on the digital printed surface using a lamination thermal roller to transfer a shape (a film mold) of the film into an ink surface to be changed into a gloss or non-gloss image shape.

In the related art, there are various post-treatment methods for a screen printed matter or an offset printed matter. The most basic post-treatment method includes a post-treatment method which coats a thermoplastic resin melting solution with a thin film or laminates a resin film in order to preserve or protect the screen printed matter or the offset printed matter or a post-treatment method which partially and splendidly decorates a surface of the printed matter by thermally welding various color thin films such as a gold foil or a silver foil to try to elevate a quality of the printed matter.

Further, in Korean Patent No. 704462, which is a specific related art which tries to elevate a quality of a printed matter using a printing post-treatment method, a partial heating embossing method which uses a thermal laminate film on a printed surface is disclosed.

According to the related art, the post-treatment is performed on a printed surface with a thermal laminate film in which a surface layer which is a biaxial oriented polypropylene film and an adhesive layer which is an ethylene vinyl acetate (EVA) resin which is a hot melt thermoplastic resin are laminated and various embossing shapes are partially formed on a printed surface on which the embossing treatment is performed to add an aesthetic characteristic or strong image to the printed pattern which may elevate a quality of a printed matter.

As another related art, Korean Patent Application Unexamined Publication No. 10-2004-32470 discloses a laminate film which three-dimensionally shows and enlarges letters or figures on a printed surface by laminating the printed surface using a post-treatment.

As described above, the post-treatment of the related art, such as a laminating treatment on the printed layer, a partial thermal welding treatment of a printed surface with a gold or silver foil, a partial formation of various shapes of embossing, a treatment of enlarging or three-dimensionally showing a printed matter necessarily uses directly or indirectly a film which may cause the corresponding function in order to provide the corresponding function and operation.

Further, as a related art for a non-gloss or gloss treatment which is used for the post-treatment of a digital printed matter according to the present invention, a post-treatment technique which performs a non-gloss and gloss treatment on a printed surface is known. In the related art, in the case of the non-gloss treatment, a matt treatment is performed on one surface of a thermoplastic resin having a relatively high melting point using a chemical method or a laminating film on which en adhesive layer is formed is laminated on the other surface of a film which is quenched by a quenching material or a non-glossy film on which an embossing treatment is performed, using a thermal roller to allow the surface layer to be a non-gloss treated surface to give a non-gloss effect to the printed matter. As another non-gloss treatment method which is a related art prior to the above-mentioned method, according to a printing post-treatment method, a printed matter on which a thermoplastic resin film having a low melting point, which is relatively easily thermally deformed, is laminated, is bonded to a thermoplastic resin film, which is hardly thermally deformed, having a relatively high melting point which is non-gloss treated and an image of the non-gloss treated surface is transferred onto the laminated film surface while the printed matter passes through a thermal roller so that a non-gloss effect of the printed surface may be achieved.

Further, a gloss treatment of the related art is a post-treatment in which a printed surface is directly laminated with an acrylic resin film or a polyethylene film which has an excellent glossy property or a film having a high melting point and a high smoothing property is bonded to a surface which is laminated with a thermoplastic film having a relatively low melting point on the printed surface in advance and the printed matter is pressurized by a roller to achieve a gloss effect on the printed surface.

As described above, in order to achieve the gloss and non-gloss effect as a printing post--treatment method of the related art, the gloss and non-gloss treated film is directly on the printed matter or the printed surface is laminated by a thermally deformed film and then transition is performed by heating and pressurizing a non-gloss treated film or a highly smoothened film surface to obtain the non-gloss or gloss effect. Therefore, according to the related art, in order to achieve the gloss or non-gloss effect, the laminate film needs to be necessarily used on the printed surface. However, according to the present invention, a post-treatment method including a gloss or non-gloss treatment which may give a non-gloss or gloss effect on the digital printed surface without using a laminate film may be provided.

### SUMMARY OF THE INVENTION

The present invention has been made in an effort to provide a method which elevates a quality of a printed matter using a post-treatment including a gloss and non-gloss treatment which gives a gloss and non-gloss effect without using a separate laminate film on a printed layer in order to add a gloss and non-gloss effect on the printed layer using a thermosetting property of a digital printed layer in consideration of a characteristic of a digital printed matter, specifically, the usage of a resin based toner or ink.

A first exemplary embodiment of the present invention provides a method of elevating a quality of a printed matter, using a printing post-treatment which laminates a glossy film on a digital printed surface to pass the printed matter through a thermally pressurizing roller and separates the glossy film to perform a gloss treatment only on the printed layer, a post-treatment which primarily prints a surface by digital printing, laminates the printed surface with a non-glossy media film, secondarily prints the printed matter thereon by digital printing and then bonds a glossy film on the printed surface to pass the printed matter through a thermally pressurizing roller to separate the glossy film to perform a gloss treatment on a secondary digital printed layer, a printing post-treatment which bonds a non-glossy film to a digital printed surface to pass the printed matter through the thermally pressurizing roller and separates and removes the non-glossy film to perform the non-gloss treatment on the printed surface, and a post-treatment which laminates a glossy media film on a digital printed surface, secondarily performs digital printing thereon, laminates a glossy or non--glossy film on the printed surface to pass the printed matter through the thermally pressurizing roller to perform a gloss or non-gloss treatment on a secondary printed layer.

According to a method of elevating a quality of a printed matter using a post-treatment including a gloss and non-gloss treatment of the present invention, a large amount of films may be saved and a post-treatment is easily performed on an image on a printed matter to be emphasized or symbolically attract an attention and various and splendid patterns may be reflected on the printed surface so that a quality of a digital printed matter is improved to obtain a high quality printed matter.

### DETAILED DESCRIPTION OF THE INVENTION

The present invention relates to a method of elevating a quality of a printed matter by a post-treatment including a gloss and non-gloss treatment using a digital printed surface without using a laminate film for a printing post-treatment which is directly or indirectly used for a post-treatment using a characteristic of a digital printing ink such as a resin based toner and ink which is not permeated onto a surface of a paper differently from offset printing ink of the related art. According to a basic embodiment of the present invention, a printing post-treatment in which a glossy film is laminated on a printed surface of a paper which is digitally printed using a digital printer and a printed matter is passed through an engagement pressurizing roller which is maintained in a temperature range of 100 to 150° C. so that a high gloss-treatment is partially performed only on a printed layer on the printed surface is performed to elevate a quality of a printed matter.

The embodiment of the present invention is a most basic method which performs a post-treatment in order to elevate a quality of a digital printed matter by showing only a portion in which a printed layer is formed such as a digitally printed letter or figure on a surface of a paper with a high glossy.

The glossy film which is used in the above-mentioned method is a PET film which is treated such that one surface thereof has a very high smoothing property and a melting point of the glossy film is much higher than that of a digitally printed thermoplastic resin ink. Further, the glossy film is hardly thermally deformed at a roller passing temperature. In a specific configuration of the glossy film, a release surface of a film where one surface having a thickness of several tens of micron is applied and laminated on a gloss-treated surface of a PET film having a highly gloss treated surface at an amount of 5 to 10 g per m² and a digitally printed surface are laminated to he passed through the thermally pressurizing roller. Here, the film having a very high smoothing property may be a film which is processed so as to have a smoothness of RZ 0.0001 or less.

According to a second embodiment, a printed surface on which digital printing is primarily performed is laminated by a non-glossy media film and digital printing is secondarily performed thereon. A glossy film is laminated on the printed surface to be passed through an engagement pressurizing roller which is maintained in the range of 100 to 150° C. to perform a post treatment which performs a gloss treatment only on a secondarily printed digital printed layer to elevate a quality of a printed matter.

The media film which is laminated on a primarily digitally printed surface has an unique essential function of a laminate film which prevents a deformation of the primarily digital printed surface due oxidation, contamination or moisture, a function of maintaining the digital printed layer to have its original status at the time of a gloss treatment of the digital printing which is subsequently performed, and an excellent adhering function with a secondarily printed digital printed layer.

The media film has a configuration in which a coat g layer formed of a water based urethane having a thickness of several micron is formed on a surface layer of a biaxial oriented PP film having a thickness of several tens of micron and an ethylene vinyl acetate adhesive layer with a thickness of several tens of micron is formed on a lower layer thereof and thus the media film is hardly affected by heat and pressure which are applied to perform a glossy and non-glossy treatment on the printed layer.

When a glossy film is used to perform the gloss treatment on a digitally printed surface on a media film on which a laminating treatment is performed using a media film, only a printed layer which is digitally printed by letters or figures shows a high glossy so that based on a digital printing which shows a printed original form, only secondarily printed digital printed layer shows a high glossy so as to elevate a quality of a printed matter.

A third embodiment is method of elevating a quality of a printed matter by improving a quality of a printed matter using a printing post-treatment in which a non-glossy film is laminated on a digital printed surface to pass the printed matter through a thermally pressurizing roller which is maintained at a temperature of 100 to 150° C. and the non-glossy film is separated and removed to perform a non-glossy treatment on a digital printed layer.

A fourth embodiment may be a post-treatment in which, in the non-glossy film treatment of the second embodiment, the non-glossy film treatment is continuous but a procedure of a non-glossy film treatment in the glossy film treatment is switched.

The non-glossy films which are used in the third and fourth embodiments are same and the glossy films which are used in the first and second embodiments are same.

According to a fifth embodiment, a portion which is desired to be partially glossy is digitally printed first and then a glossy film is laminated on the partial glossy portion to pass through a thermally pressurizing roller which is maintained at a temperature of 100 to 150° C. and then the glossy film is separated so that the printed surface is gloss treated and a background portion is secondarily digitally printed to elevate a quality of a printed matter using a partial gloss treatment. Further, the quality of the printed matter may he elevated using a combination of other components.

The non-glossy film which is used in the third and fourth embodiments is a non-glossy film on which a silicon release layer is formed on one matt treated surface of a PET film which has a high melting point and is hardly thermally deformed. According to a specific configuration of the non-glossy film, a matt layer having a thickness of several microns is formed on one surface of a PET film having a thickness of several tens of microns and a silicon release layer on which a release agent of 5 to 10 g/m² is applied is formed on the matt layer.

According to the present invention, in order to obtain gloss or non-gloss effect of the related art, the gloss or non-gloss effect is obtained not by laminating a gloss or non-gloss treated film on a screen or offset printed surface or laminating a thermally deformed film on a printed surface and transiting the gloss or non-gloss treated film surface onto a film surface using thermal deformation, but by a common post-treatment in which using a characteristic of digital printing, specifically, using a characteristic of digital printing ink, a gloss or non-gloss treated film surface shape, that is, a kind of a film mold is directly transferred onto a digital printed layer by a thermally pressurizing means.

The post-treatment in which a gloss or non-gloss effect is achieved may be applied only to a printed layer which is printed using a digital printing method but not applied to a screen or offset printed surface and no effect may be obtained.

Further, according to the related art, in order to achieve the gloss and non-gloss effect, the laminate film is necessarily used. However, in the present invention, a media film having a multi-purpose function may or may not be used for the gloss and non-gloss treatment, which may advantageously save the film. Further, when the media film is used, the media film has a high melting point so that the media film is used to perform a unique function of the laminate film for protecting a printed matter, a blocking function between printed layers in order to prevent a color deformation due the mixture of color between the primarily printed layer and a secondarily printed layer or a function of improving the adhesive property of the printed layer but the media film is not used to transit a gloss or non-gloss film image.

Features of the printing post-treatment method including the glossy and non-gloss treatment of the present invention are as follows. First, the gloss and non-gloss post-treatment method of the present invention is applied to a digital printed matter so that the same effect is obtained and the quality of the printed matter is improved to elevate the printed matter.

Second, the post-treatment which may achieve the non-gloss and gloss effect is directly performed on the digital printed surface so that no separate film which may give a gloss and non-gloss effect is used, which may save a raw material.

Third, the gloss and non-gloss effect is selectively achieved only on a printed layer of the digital printed matter so that an image which may be emphasized or symbolically represented on the printed matter is easily post-treated.

Fourth, various and splendid patterns may be achieved on a printed surface using a post-treatment including a gloss or a non-gloss, a gloss and non-gloss multiple printing, and a blocking process of a printed layer of a media film so that a quality of a digital printed matter is elevated to obtain a high quality printed matter.

1. A method of elevating a quality of a printed matter using a printing post-treatment, comprising:
laminating a glossy film on a digital printed surface;
allowing a printed matter to pass through a thermally pressurizing roller which is maintained at a temperature of 100 to 150° C.; and
separating the glossy film to perform a gloss treatment only on a printed layer.

2. The method of claim 1, wherein the glossy film is a PET film which is treated so as to have a smoothing property of RZ 0.0001 or higher and has a melting point higher than a digitally printed thermoplastic resin ink and is not thermally deformed at a temperature of 100 to 150° C. at which the thermal thermally pressurizing roller is maintained.

3. A method of elevating a quality of a printed matter using a printing post-treatment, comprising:
laminating a printed surface on which primary digital printing is performed with a media film;
secondarily performing digital printing thereon;
bonding a glossy film onto the printed surface;
allowing a printed matter to pass through a thermally pressurizing roller which is maintained at a temperature of 100 to 150° C.; and
separating the glossy film to perform gloss treatment on a secondarily printed digital printed layer.

4. The method of claim 3, wherein the media film is a film on Which a water based urethane coating layer having a thickness of several micron is formed on a surface layer of a biaxial oriented polypropylene film having a thickness of several tens of micron and an ethylene vinyl acetate (EVA) resin adhesive layer having a thickness of several tens of micron is formed on a release layer.

5. A method of elevating a quality of a printed matter using a printing post-treatment, comprising:
digitally printing a portion to be partially glossy;
laminating a glossy film;
allowing a printed matter to pass through a thermally pressurizing roller which is maintained at a temperature of 100 to 150° C.;
separating the glossy film to perform gloss treatment on a printed surface; and
performing again a partial gloss treatment by secondarily performing digital printing on a background portion.

6. A method of elevating a quality of a printed matter using a printing post-treatment, comprising
laminating a non-glossy film on a digital printed surface;
allowing a printed matter to pass through a thermally pressurizing roller which is maintained at a temperature of 100 to 150° C.; and
separating the non-glossy film to perform non-gloss treatment on a digital printed layer.

7. The method of claim 6, wherein the non-glossy film is a non-glossy film on which a silicon release layer is formed on one surface of a PET film on which a matt treatment is performed.
